(19) United States
(12) Patent Application Publication
(10) Pub. No.: US 2022/0220920 A1
(43) Pub. Date: Jul. 14, 2022

(54) PISTON RING GROOVE INSERT AND METHODS OF MAKING

(71) Applicant: MATERION CORPORATION, Mayfield Heights, OH (US)

(72) Inventors: Andrew Tarrant, Mayfield Heights, OH (US); David TRICKER, Mayfield Heights, OH (US); Steffen MACK, Mayfield Heights, OH (US); David KRUS, Mayfield Heights, OH (US); Andrew RUZEK, Mayfield Heights, OH (US); Fritz GRENSING, Mayfield Heights, OH (US)

(73) Assignee: MATERION CORPORATION, Mayfield Heights, OH (US)

(21) Appl. No.: 17/570,859

(22) Filed: Jan. 7, 2022

Related U.S. Application Data
(60) Provisional application No. 63/135,473, filed on Jan. 8, 2021.

(51) Int. Cl. F02F 3/00; B22D 21/00; C22C 21/16; C22C 21/14; F16J 9/22

(52) U.S. Cl. CPC F02F 3/0084; B22D 21/007; F16J 9/22; C22C 21/14; C22C 21/16

(57) ABSTRACT

The present disclosure relates to piston assembly comprising a piston having a circumferential groove and a ring groove insert within the circumferential groove of the piston. Particularly, the ring groove insert is a second material different from a first material of the piston. The second material has at least one of the following: a) a density from 90% to 120% of a density of the first material; b) a coefficient of thermal expansion (CTE) from 50% to 90% of a CTE of the first material; or c) a thermal conductivity greater than a thermal conductivity of the first material.

### PRIORITY

This application is related to and claims priority to U.S. Provisional Patent Application No. 63/135,473 filed Jan. 8, 2021, which is incorporated herein by reference.

### TECHNICAL FIELD

This invention relates to piston ring groove inserts for use in internal combustion engines, and in particular piston ring groove inserts made of a solid material having physical properties different than the piston. Also described herein are methods for producing the piston ring groove inserts made of the solid material.

### BACKGROUND

Most turbocharged, or otherwise boosted, internal combustion engines in passenger cars use aluminum pistons which are cast around a steel piston ring insert that functions as the compression ring groove. The function of the piston ring is to prevent premature wear of the groove, fatigue cracking at the top land, and to protect against erosion from pre-combustion events in and around the groove.

While steel ring groove inserts demonstrate sufficient resistant to wear, erosion, and fatigue problems that limit the lifetime and application over unreinforced aluminum, or even anodized aluminum, ring groove inserts in pistons, steel ring groove inserts present many disadvantages. Steel has a higher density than aluminum, thus a steel insert adds reciprocating mass to the piston, which reduces engine efficiency and increases fuel consumption. Compared to aluminum, steel ring groove inserts have a very low thermal conductivity, thus acting as a thermal barrier placed directly in the heat conduction pathway from the heat source (combustion chamber) through the piston ring and into the engine block, and to the oil-cooled piston undercrown. Additionally, the coefficient of thermal expansion (CTE) of steel is generally half that of aluminum. Therefore, as the piston heats up, the aluminum will expand faster than the steel insert stressing the bond between the insert and the piston, which may lead to failure.

### BRIEF DESCRIPTION

As described herein are processing methods for making ring groove inserts made of metal matrix composites (MMC), which allow for pistons to be produced by casting or forging, or other techniques, around the insert without causing the insert to deform or melt at the piston forming temperature. The process finds particular use for ring groove insert materials having a plurality of ceramic particles dispersed in a metal matrix, where the insert material is a preformed solid. The ceramic particles do not melt or deform at processing temperatures to make the piston assembly and also provide long life at operating temperatures.

The ring groove inserts as described herein provide tailored properties such as density, CTE, thermal conductivity, and wear resistance suitable for piston assemblies. It would be desirable to be able to manufacture pistons having preformed solid insert materials that do not add mass to the total piston for improved engine efficiency and have a closely matched CTE to the piston material for improved bond between the piston and the insert, while also having a high thermal conductivity for better heat dissipation out of the groove and into the piston ring or to the oil-cooled undercrown.

In one aspect there is provided a piston assembly comprising a piston having a circumferential groove and a ring groove insert within the circumferential groove of the piston. The ring groove insert preferably has an outer surface and an inner surface. The ring groove insert is a second material different from a first material of the piston and the second material has at least one of the following:
a) a density from 90% to 120% of a density of the first material;
b) a coefficient of thermal expansion (CTE) from 50% to 90% of a CTE of the first material; or
c) a thermal conductivity greater than a thermal conductivity of the first material.

The first material of the piston may be aluminum, aluminum alloy, magnesium, magnesium alloy, or combinations thereof. In some embodiments, the piston is an aluminum alloy including one or more alloying elements of silicon, copper, manganese, magnesium, iron, zinc, nickel, scandium, lithium, titanium, zirconium, or tin. The aluminum alloys may have a melting temperature different than the second material, in particular the differential being from 20° C. to 80° C.

The ring groove insert is a second material that preferably maintains its dimensional shape above the melting temperature of the first material, such as up to a temperature of 725° C. or more preferably 1000° C. In some embodiments, the second material may be a metal matrix composite (MMC) including a matrix of aluminum, aluminum alloy, magnesium, magnesium alloy, titanium, titanium alloy, or combinations thereof and from 5 vol % to 60 vol % of reinforcement particles dispersed within the matrix based upon the total volume of the second material. In some embodiments, the matrix is an aluminum alloy of more than 88 wt % aluminum.

The ring groove insert comprising the second material may include reinforcement particles having a hardness greater than the hardness of the matrix. In some embodiments, the reinforcement particles have a hardness greater than 8 and the matrix has a hardness less than 4, or the reinforcement particles have a hardness from 9 to 10 and the matrix has a hardness from 2 to 3, wherein hardness is measured according to the Mohs Hardness Scale. The reinforcement particles may include at least one plurality of ceramic particles. In some embodiments, the reinforcement particles include carbides, oxides, silicides, borides, nitrides, or combinations thereof. The at least one plurality of reinforcement particles may preferably include silicon carbide, boron carbide, titanium carbide, silicon boride, aluminum nitride, silicon nitride, titanium nitride, alumina, or combinations thereof. The average particle size of the reinforcement particles may be from 0.01 μm to 10 μm.

The ring groove insert material may be an MMC including from 5 vol % to 60 vol % of the reinforcement particles based upon the total volume of the second material, or preferably 15 vol % to 50 vol % of the reinforcement particles based upon the total volume of the second material, or more preferably 15 vol % to 30 vol % of the reinforcement particles based upon the total volume of the second material.

The ring groove insert material may have a density from 2.5 g/cm³ to 3.0 g/cm³. The ring groove insert material may have a thermal conductivity from 140 to 170 W/m° K. The ring groove insert material may have a coefficient of thermal expansion from 15 ppm/° C. to 25 ppm/° C. The ring groove insert material may have a porosity of less than or equal to 0.5%. Preferably, the ring groove insert material has any combination or all of the aforementioned.

In one aspect there is provided a preformed ring groove insert. The ring groove insert may be a preformed solid having:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%, wherein the insert includes 5 vol % to 60 vol % of a plurality of ceramic particles in a metal matrix. The preformed solid ring groove insert may include the plurality of ceramic particles having an average particle size distribution (D50) from 0.01 μm to 10 μm. The preformed ring groove insert may include the plurality of ceramic particles having an internal surface area from 100 mm²/mm³ to 1000 mm²/mm³.

The ring groove insert material may maintain its dimensional shape as measured by the surface area of a first volume fraction of the another aluminum alloy matrix relative to the surface area of a second volume fraction of the reinforcement particles. The inner surface of the ring groove insert may have a surface roughness (Ra) of 0.4 μm or more. The inner surface of the ring groove insert may have a surface roughness (Ra) of 0.4 μm or more. A portion of the ring groove insert may extend into the top land of the piston. A distance measured from the top of the uppermost one or more grooves to the top of the piston is reduced by at least 10% compared with a reference steel insert.

The piston assembly may include an interfacial region between the inner surface of the ring groove insert and the piston. The interfacial region may include at least one intermetallic secondary phase. The interfacial region may include a diffusion control coating separating the first material of the piston and the second material of the ring groove insert. The interfacial region may include a coating of aluminum, copper, nickel, zinc, or combinations thereof. In some embodiments, the interfacial region includes at least one intermetallic secondary phase including aluminum, copper, nickel, zinc, or combinations thereof. The interfacial region may be enriched in one or more alloying elements of copper, manganese, magnesium, iron, zinc, or nickel migrating from a first aluminum alloy of the piston, and particularly the interfacial region may be enriched in at least one of magnesium and nickel. The ring groove insert material may be an MMC including an aluminum alloy and from 5 vol % to 60 vol % of reinforcement particles, wherein the interfacial region has a ratio of reinforcement particles to matrix phase of less than or equal to 1/500. The interfacial region may have a porosity of less than or equal to 5%.

In another aspect there is provided a method of making the piston assembly comprising providing a ring groove insert and die casting a metal or metal alloy around the ring groove insert at or above the solidus temperature of the metal or metal alloy to form a cast piston assembly. The ring groove insert may be a preformed solid having:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%.

The method may include coating the ring groove insert before die casting. The method may include increasing the surface area of the ring groove insert before die casting. The method may further include at least one of heat treating, quenching, and ageing the cast piston assembly after die casting. The method may further include forming at least one ring groove in the ring groove insert, the at least one ring groove for receiving a piston ring.

In yet another aspect there is provided an internal combustion engine comprising a piston cylinder and a piston assembly within the piston cylinder. The piston assembly may include a piston having a circumferential groove and a ring groove insert within the circumferential groove of the piston. The ring groove insert may have an outer surface and an inner surface. The ring groove insert may be a second material different from a first material of the piston. The second material has at least one of the following:
a) a density from 90% to 120% of a density of the first material;
b) a coefficient of thermal expansion (CTE) from 50% to 90% of a CTE of the first material; or
c) a thermal conductivity greater than a thermal conductivity of the first material.

The internal combustion engine may include at least one piston ring disposed between the piston assembly and the piston cylinder in another circumferential groove extending radially inward from the outer surface of the ring groove insert. The ring groove insert may provide a 2.5% weight reduction over a comparative steel ring groove insert to yield a CO₂ reduction of at least 2.3 kg CO₂/liter petrol in the internal combustion engine. The engine may have a reduction of hydrocarbon, nitrous oxides, and carbon oxides emissions, but without reducing combustion pressure and/or engine efficiency. The CO₂ emissions may be reduced by at least 10% compared with a reference steel insert.

In yet another aspect there is provided a vehicle comprising the internal combustion engine as described above. These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a diagram illustrating an exemplary vehicle in accordance with some embodiments of the present disclosure.

FIG. 2 is an illustration of a piston assembly produced in accordance with some embodiments of the present disclosure.

FIG. 3A is an illustration of a piston for a piston assembly in accordance with some embodiments of the present disclosure.

FIG. 3B is an illustration of a ring groove insert for a piston assembly in accordance with some embodiments of the present disclosure.

FIG. 3C is an illustration of a piston assembly including a piston cast around an insert produced in accordance with some embodiments of the present disclosure.

FIG. 3D is another illustration of a piston assembly including a piston cast around an insert produced in accordance with some embodiments of the present disclosure.

FIG. 3E is yet another illustration of a piston assembly including a piston forged around an insert produced in accordance with some embodiments of the present disclosure.

FIG. 4 is a scanning electron micrograph of an interfacial region of a piston assembly produced in accordance with some embodiments of the present disclosure.

FIG. 5A is a scanning electron micrograph of an interfacial region of a piston assembly including a layer of copper between the piston and the insert produced in accordance with some embodiments of the present disclosure.

FIG. 5B is a scanning electron micrograph of an interfacial region of a piston assembly including a layer of nickel/copper between the piston and the insert produced in accordance with some embodiments of the present disclosure.

FIG. 6 is a scanning electron micrograph of an interfacial region of a piston assembly including a layer of nickel/copper between the piston and the ring groove insert and subsequently heat treated in accordance with some embodiments of the present disclosure.

FIG. 7A is a plot showing ring specific wear rate (k)(1/psi) as a function of final contact pressure (psi) for various materials including the insert produced in accordance with some embodiments of the present disclosure.

FIG. 7B is a plot showing ring specific wear rate (k)(1/psi) as a function of load (lbf) for various materials including the insert produced in accordance with some embodiments of the present disclosure.

FIG. 8A is a plot showing disc loss vs steel pin data at 20 N, 35 N, and 50 N according to ASTM G99 for various materials including the insert produced in accordance with some embodiments of the present disclosure.

FIG. 8B is another plot showing disc loss vs steel pin data at 20 N, 35 N, and 50 N for various materials including the insert produced in accordance with some embodiments of the present disclosure.

FIG. 9 is a plot showing the combined steel pin loss and disc loss (by sides of the wear couple) vs discs at 20 N, 35 N, and 50 N for various materials including the insert produced in accordance with some embodiments of the present disclosure.

FIG. 10A is a plot showing the internal surface area (mm²/mm³) of the matrix of the MMC insert material as a function of the volume fraction of ceramic particles (from 10 vol % to 50 vol %) within the matrix of the insert material for ceramic particles having an average particle size distribution of from 0.1 μm to 50 μm in accordance with some embodiments of the present disclosure.

FIG. 10B is a plot showing the preferred region of internal surface area (mm²/mm³) of the matrix of the MMC insert material as a function of the volume fraction of ceramic particles from 10 vol % to 30 vol % using ceramic particles having an average particle size distribution of from 1.0 μm to 10 μm in accordance with some embodiments of the present disclosure.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams or 10 grams, and all the intermediate values).

When a material is described as having an average particle size or average particle size distribution, which is defined as the particle diameter at which a cumulative percentage of 50% (by volume) of the total number of particles are attained. In other words, 50% of the particles have a diameter above the average particle size, and 50% of the particles have a diameter below the average particle size. The size distribution of the particles will be Gaussian, with upper and lower quartiles at 25% and 75% of the stated average particle size, and all particles being less than 150% of the stated average particle size.

The process steps described herein refer to temperatures, and, unless provided for, this refers to the temperature attained by the material that is referenced, rather than the temperature at which the heat source (e.g. furnace, oven) is set. The term “room temperature” refers to a range of from 20° C. to 25° C. (68° F. to 77° F.).

### Internal Combustion Engine

Piston assemblies as described herein are suitable for use in an internal combustion engine for a vehicle. By providing ring groove inserts as described herein, the overall mass of the piston assembly is reduced as compared to aluminum piston/steel insert assemblies. Efficiency effects resulting from incorporating the ring groove inserts into piston assemblies outweigh any additional materials costs while further providing benefit to the environment by reducing CO₂ emissions. An estimated 15% reduction in oscillating mass reduces fuel consumption by 1.6-2.6 liters/100 km. (Schwaderlapp, et. al., “Friction Reduction—the Engine's Mechanical Contribution to Saving Fuel”; Seoul 2000 FISITA World Automotive Congress, Paper No. F2000A165, pp. 1-8, June 12-15, 2000, Seoul, Korea.) ‘Insert A’ will be referred to as representative of ring groove inserts for piston assemblies as described herein for illustrative purposes. An example calculation of the mass reduction for Insert A translates into a reduction of fines of €76 per vehicle (using a 2.3 liter EcoBoost as a baseline for the calculation). The calculation is based upon a reciprocating mass per cylinder of 1082 g. Insert ‘A’ weighs 27 g less than a steel insert resulting in a 2.5% mass reduction. The 2.5% mass reduction provides ⅙ of 2.1 l/100 km=−0.35 l/100 km, using 2.1 l/100 km as the average of the reference range 1.6-2.6 liters/100 km. The CO₂ reduction is then −0.35 l/100 km or −0.8 g/km (2.3 kg CO₂/liter petrol). Thus the reduction in fines is 0.8 g/km×€95/g CO₂/km, which is equal to €76 per vehicle. Inserts such as Insert A, which are preformed solid inserts, can readily be substituted for steel inserts in current manufacturing processes, and additionally yield environmental as well as cost benefits as detailed above.

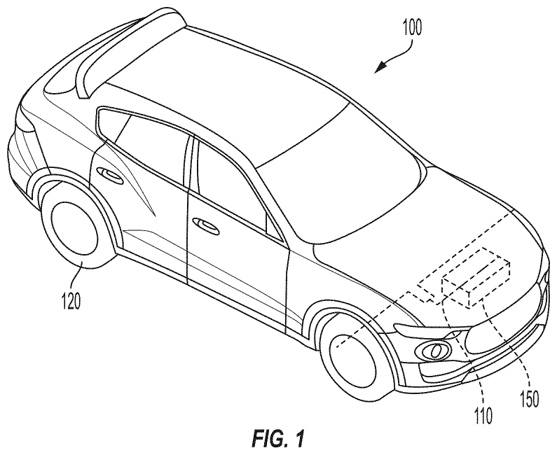

As illustrated schematically in FIG. 1, vehicle 100 includes an engine 150, a drive train 110, and wheels 120 among other components for moving the vehicle. The engine 150 may be or include an internal combustion engine. An internal combustion engine includes combustion taking place within a piston cylinder with the combustion gases forcing a piston to move downward. Engine 150 includes a piston assembly as described herein including inserts, such as Insert A discussed above.

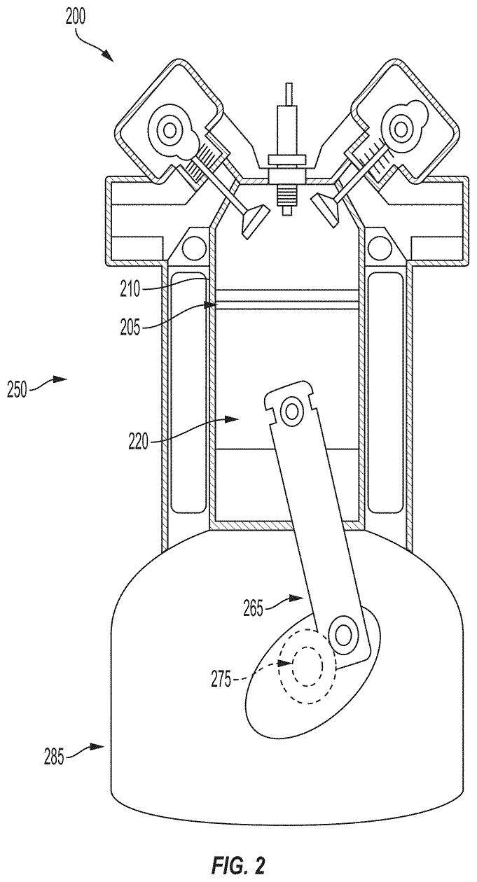

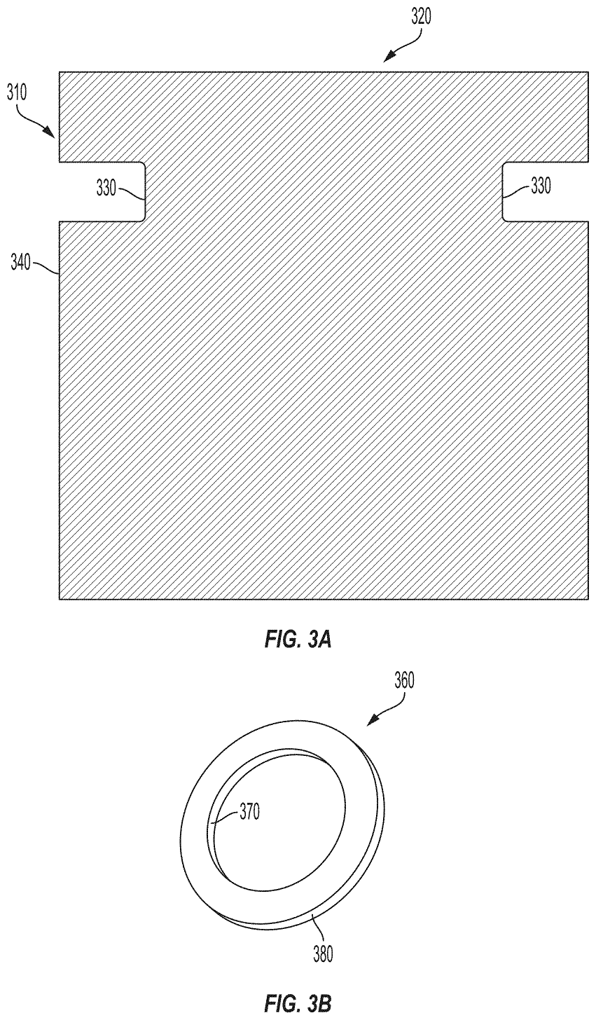

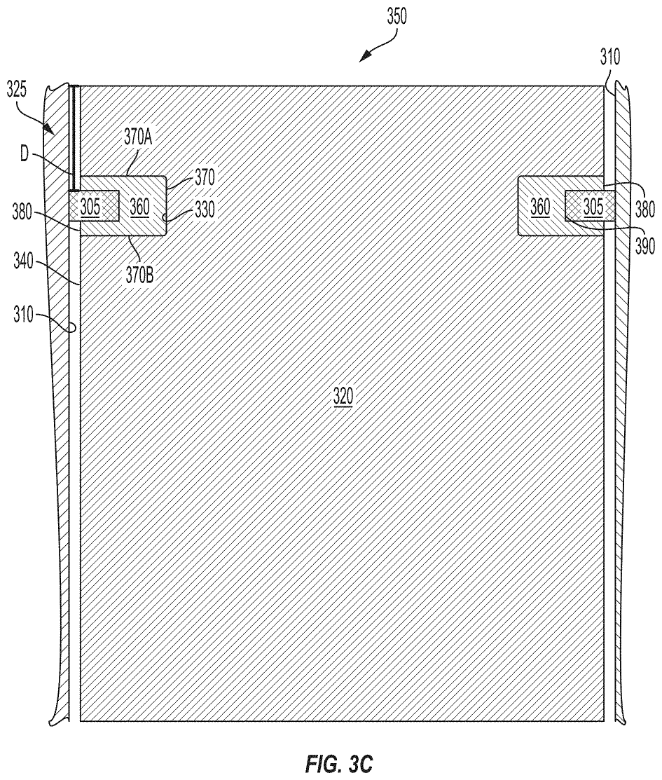

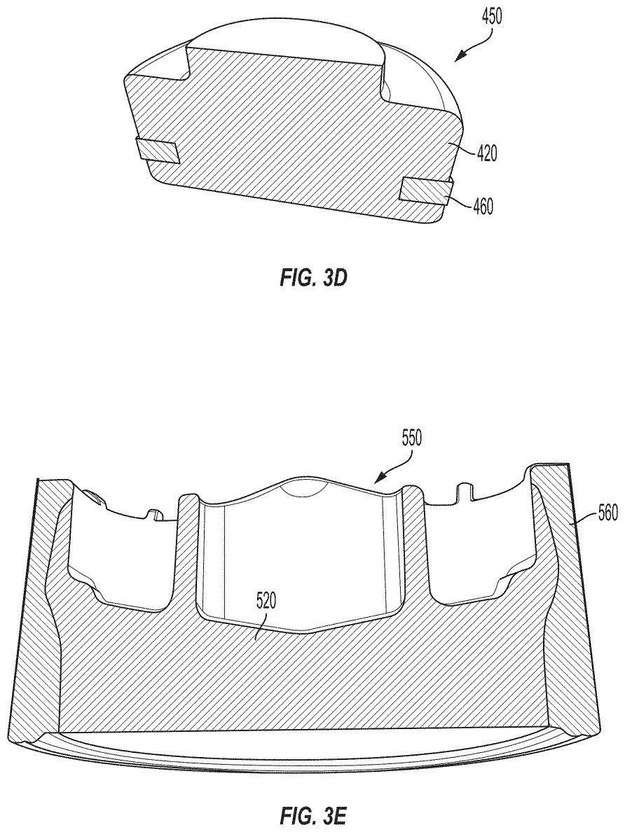

As illustrated schematically in FIG. 2, the expansion of gas within internal combustion engine 200 due to the application of heat then forces the gas to compress and to act against the head (or top) of the piston 220 causing the piston to move downward within the cylinder 210. The piston is movable up and down to generate a circular motion via a connecting rod 265 in connection to a crankshaft 275. A piston assembly 250, according to embodiments herein within a piston cylinder, includes a piston 220 having at least one circumferential groove 230. In the embodiments described herein, piston 220 including the at least one circumferential groove 230 further includes a ring groove insert (as shown in FIG. 3A) within the piston circumferential groove 230. As understood by those skilled in the art, the term ring groove inserts, or simply inserts, may also be interchangeably referred to as carriers or ring groove carriers.

In some embodiments, the ring groove insert provides an advantageous weight reduction. For example, the ring groove insert made of a second material different from a first material of the piston provides a 2.5% weight reduction to the internal combustion engine over a comparative steel ring groove insert to yield a CO₂ reduction of at least 2.3 kg CO₂/liter petrol.

Overall piston temperature will be cooler because the ring groove insert will have a thermal conductivity 3× to 6× greater than that of conventionally used materials such as cast iron. This promotes heat transfer from the uppermost piston ring to the cylinder wall.

A significantly cooler piston crown provided by using the piston ring inserts as described herein allows increase the compression ratio and/or which results in gains in efficiency and prevents or reduces knocking by allowing full compression.

In some embodiments, the internal combustion engine demonstrates a wear resistance of the ring groove insert is greater than that of the piston material in the piston assembly. The wear resistance of the ring groove insert is also equal to or greater than that of cast iron.

In some embodiments, the internal combustion engine demonstrates a reduction of hydrocarbon, nitrous oxides, and carbon oxides emissions, but without reducing combustion pressure and/or engine efficiency. Embodiments herein raise the ring groove insert higher to the top of the piston. This reduced distance between the top of the piston ring to the top land of the piston is possible due to the enhanced cooling characteristics, including high thermal conductivity, of the insert. The reduced distance between the piston ring and the top of the piston results in reduced crevice volume, reduced hydrocarbon emissions, and increased engine efficiency. The compression ratio, depending upon engine design, may also then be lowered.

### Piston Assembly Configuration

A piston assembly 350, for providing within a piston cylinder for an internal combustion engine as described in FIG. 2, is illustrated in cross sectional views FIG. 3A-3C. Piston 320 has a head 325 or top land portion as shown in FIG. 3A. Within the piston head 325 of piston 320 is circumferential groove 330. Ring groove insert 360 is disposed within the circumferential groove 330 of the piston head 325. Ring groove insert 360 of FIG. 3B has an inner surface 370 and an outer surface 380. Outer surface 380 is flush with an outer circumferential surface 340 of piston 320 as shown in FIG. 3C. Outer surface 380 further includes another circumferential groove extending radially inward from the outer surface 380 of the ring groove insert to provide a circumferential groove 390 for carrying a piston ring (not shown). Inner surface 370 of ring groove insert 360 includes one or more surfaces including, for example, 370A and 370B as shown. Inner surface 370 of ring groove insert 360 may be of any shape suitable for processing within a piston to make a monolithic piston assembly. Inner surface 370 may include rounded, chamfered, sinusoidal, scalloped surfaces. Features of the inner surface may be machined, stamped, or coined into the ring groove insert 360. There is preferably no gap, and no porosity, between inner surface 370 and circumferential groove 330. The inner surface 370 is herein defined as the surface coupled with or otherwise mated to the circumferential groove 330. Circumferential groove 330 may include a complementary shape, such as rounded, chamfered, sinusoidal, scalloped surfaces, to form around and accommodate the inner surface 370. Inner surface 370 is bonded either directly having no coating or indirectly with coating to circumferential groove 330. In some embodiments, an interfacial region is disposed between inner surface 370 and circumferential groove 330, as will be detailed below. Piston ring 305 is disposed within circumferential groove 390 of ring groove insert 360 between piston 320 and piston cylinder wall 310. Distance D is defined between the top of piston ring 305 and the top of piston 320 or as the distance between point 345 of groove 390 and the top of piston 320. A circumferential volume between piston 320 and cylinder wall 310 that includes distance D is defined as the crevice volume. Insert 360 allows distance D to be minimized with the insert 360 so that the crevice volume is minimized. Distance D may also be referred to as the top land length. In some embodiments, distance D is reduced by at least 10%, at least 20%, at least 30%, or at least 40% as compared with a conventional steel insert.

In addition to the configuration of the piston assembly as shown in FIG. 3C, piston assemblies as contemplated herein may include more than one ring groove insert and/or one or more circumferential grooves extending inward from the outer surface (such as surface 380 of the ring groove insert of FIG. 3B and FIG. 3C) of the insert. In other words, piston assemblies as described herein may be configured to accommodate one or more piston rings. FIG. 3D illustrates piston assembly 450 having piston 420 cast around insert 460. Insert 460 is shown prior to further processing, for example, to machine the outer surface of insert 460 to be flush with the outer surface of piston 420 and before a groove (such as groove 390 in FIG. 3C) is machined into the insert portion of piston assembly 450. FIG. 3E illustrates piston assembly 550 having piston 520 forged around insert 560. Insert 560 is shown prior to further processing, e.g., machining one or more grooves into the outer surface of insert 560.

In some embodiments, a portion of the ring groove insert extends into the top land of the piston head or the piston ring may be moved closer to the piston crown (at top of piston head) reducing distance D as in FIG. 3C, thus reducing crevice volume and reducing the tendency for pre-ignition. The configuration may include shorter pistons and/or longer connecting rods. Shorter pistons reduce the reciprocated mass in the engine and longer connecting rods reduce the frictional loss caused by radial forces pushing the piston against the liner. Both reducing volume and tendency for pre-ignition increase engine efficiency.

Piston rings suitable in the piston assemblies described herein may include conventional, iron-based materials used to make compression rings or any commercially available piston ring. The most common piston ring material is a chrome (stainless) steel, which is usually coated with CrN, hard chrome, DLC or another low-friction, wear-resistant coating. Piston rings can also be made from cast iron, which is coated with similar coatings as used on the chrome (stainless) steel. Piston rings may be made of materials having high thermal conductivity and a lower coefficient of friction against the piston groove ring insert. In a non-limiting example, the piston compression rings are made of a copper-containing alloy that comprises copper, nickel, silicon, and chromium. These copper alloys may have several times the thermal conductivity compared to conventional, iron-based materials used to make compression rings. The copper-nickel-silicon-chromium-containing alloys have higher strength at the piston operating temperatures than do other high conductivity alloys. These alloys also possess the stress relaxation resistance and wear resistance required in compression rings. The piston ring is sized to fit within into groove (e.g., groove 390 of FIGS. 3A and 3C) for a good seal. The size of the ring will depend on the engine size. It is contemplated that the ring could have an inner diameter (i.e. bore) of as much as 1000 millimeters, or even greater.

By using a piston ring material with higher thermal conductivity, heat will be transferred more quickly away from the ring groove, through the piston ring and into the cylinder liner. The lower temperature in the ring groove increases the yield strength of the piston material in the groove, and also increases the fatigue strength. The higher thermal conductivity ring material allows the top ring groove to be placed closer to the piston crown without risk of excessive groove wear.

### Piston Assembly Materials

The piston assemblies as described herein include a piston and a ring groove insert, where the two components are of different materials but are joined together to provide a monolithic unit as shown in the examples of FIGS. 3D and 3E. In some embodiments, the piston is a first material and the ring groove insert is a second material. The second material or insert material is different from the first material of the piston head. The second material of the ring groove insert may be a solid, dense material that is pre-formed prior to integrating with the piston, by any of the various methods detailed below.

Piston materials may include any material suitable for pistons. In some embodiments, the piston is aluminum, an aluminum alloy, magnesium, a magnesium alloy, or combinations thereof. Preferably, the piston material is an aluminum alloy and may include one or more alloying elements including silicon, copper, manganese, magnesium, iron, zinc, nickel, scandium, lithium, titanium, zirconium, or tin.

The aluminum alloy of the piston material may be more than 82 wt % of aluminum. The aluminum alloy used in the piston may include a 2000 series aluminum alloy (i.e., aluminum alloyed with copper), a 6000 series aluminum alloy (i.e., aluminum alloyed with magnesium and silicon), or a 7000 series aluminum alloy (i.e., aluminum alloyed with zinc). Non-limiting examples of suitable aluminum alloys include 2124, and 2168.

In some embodiments, the aluminum alloy of the piston material is a 2124 alloy including from 93.5 wt % aluminum, from 4.4 wt % copper, 1.5 wt % magnesium, and 0.6 wt % manganese.

In other embodiments, the aluminum alloy of the piston material is an alloy including from 82.5 wt % to 86.3 wt % aluminum, from 11.0 wt % to 13.0 wt % silicon, from 0.7 wt % to 2.5 wt % nickel, 0.7 wt % to 2.5 wt % magnesium, and 0.7 wt % to 2.5 wt % copper. In a preferred embodiment, the piston material is an aluminum alloy consisting of from 11.0 wt % to 13.0 wt % silicon, from 0.7 wt % to 2.5 wt % nickel, 1.0 wt % magnesium, 1.0 wt % copper, and the balance aluminum. In some embodiments, the piston material is an aluminum alloy including 12.6 wt % silicon.

In yet other embodiments, the aluminum alloy of the piston material is a 2618 alloy including from 92.6 wt % to 94.9 wt % aluminum, from 0.10 wt % to 0.25 wt % silicon, from 0.9 wt % to 1.3 wt % iron, from 1.9 wt % to 2.7 wt % copper, from 1.3 wt % to 1.8 wt % magnesium, from 0.9 wt % to 1.2 wt % nickel, from 0.04 wt % to 0.10 wt % titanium, and optionally up to 0.10 wt % zinc. In a preferred embodiment, the piston material is an aluminum alloy consisting of from 0.10 wt % to 0.25 wt % silicon, from 0.9 wt % to 1.3 wt % iron, from 1.9 wt % to 2.7 wt % copper, from 1.3 wt % to 1.8 wt % magnesium, from 0.9 wt % to 1.2 wt % nickel, from 0.04 wt % to 0.10 wt % titanium, optionally up to 0.10 wt % zinc, and the balance aluminum.

Pistons as described herein, such as piston 320 of FIG. 3C, comprising a first material, are characterized by a first density (ρ₁), a first thermal expansion (CTE₁), and a first thermal conductivity (TC₁).

Insert materials are made of a second material different than the first material of the piston. In some embodiments, the insert material is a metal matrix composite (MMC). The metal matrix may include a matrix of aluminum, an aluminum alloy, magnesium, a magnesium alloy, titanium, a titanium alloy, or combinations thereof. The metal matrix may further include from 5 vol % to 60 vol % of reinforcement particles dispersed within the matrix based upon the total volume of the second material.

Ring groove inserts as described herein, such as insert 360 of FIG. 3C comprising a second material, are characterized by a second density (ρ₂), a second thermal expansion (CTE₂), and a second thermal conductivity (TC₂).

The second material of the ring groove insert may have at least one of the following a) a density from 90% to 120% of a density of the first material of the piston; b) a coefficient of thermal expansion (CTE) from 50% to 90% of a CTE of the first material of the piston; or c) a thermal conductivity greater than a thermal conductivity of the first material of the piston. In some embodiments, the second material of the insert has at least two of the following a) a density from 90% to 120% of a density of the first material of the piston; b) a coefficient of thermal expansion (CTE) from 50% to 90% of a CTE of the first material of the piston; or c) a thermal conductivity greater than a thermal conductivity of the first material of the piston. In other embodiments, the second material of the insert has the following a) a density from 90% to 120% of a density of the first material of the piston; b) a coefficient of thermal expansion (CTE) from 50% to 90% of a CTE of the first material of the piston; and c) a thermal conductivity greater than a thermal conductivity of the first material of the piston.

The density of the insert, ρ₂, may be from 0.9ρ₁ to 1.2ρ₁. In some embodiments, the density of the insert, ρ₂, is about equal to the density of the piston, ρ₁; or ρ₁=ρ₂. Example densities of the insert, ρ₂, may be from 2.5 g/cm³ to 3.5 g/cm³, such as from 2.7 g/cm³ to 3.1 g/cm³, 2.8 g/cm³ to 3.0 g/cm³, or 2.85 g/cm³ to 2.90 g/cm³. The relatively low density of the insert, ρ₂, provides a significant advantage over conventional steel inserts. In general the density of the piston groove inserts is at least one-third of that of a conventional steel insert (ρₛₜₑₑₗ). Having a lower density allows the piston ring inserts to achieve a density, ρ₂, from 0.25 ρₛₜₑₑₗ to 0.50 ρₛₜₑₑₗ. The low density ratio permits the inserts as described herein to have lower reciprocating mass thereby increasing engine efficiency and/or decreasing fuel consumption.

In some embodiments, the coefficient of thermal expansion of the insert, CTE₂, is from 0.5 CTE₁ to 0.9 CTE₁ of the piston material. In some embodiments, the coefficient of thermal expansion of the insert, CTE₂, is less than the coefficient of thermal expansion of the piston, CTE₁. In some embodiments, the coefficient of thermal expansion of the insert, CTE₂, is equal to or about equal to the coefficient of thermal expansion of the piston, CTE₁; or CTE₁=CTE₂. Example CTE's of the insert, CTE₂, may be from 10 ppm/° C. to 30 ppm/° C., 15 ppm/° C. to 25 ppm/° C., or 15 ppm/° C. to 20 ppm/° C. By comparison, the CTE of steel, CTEₛₜₑₑₗ, is thermal expansion mismatch with an aluminum piston where the CTE is generally one-half of that of an aluminum piston. As a comparative assembly having an aluminum piston/steel insert heats up, the aluminum expands faster than the steel insert, which stresses the bond between the insert and the piston. By tailoring the thermal expansions of the first piston material and the second insert material as described herein, an improved bond between the piston and insert results while also providing for longer life of the assembly.

In some embodiments, the thermal conductivity of the insert, TC₂, is greater than the thermal conductivity of the piston material, TC₁; or TC₂>TC₁. Example thermal conductivities of the insert, TC₂, may be from 140 W/m° K to 170 W/m° K, or from 150 W/m° K to 160 W/m° K. In some embodiments, the thermal conductivity of the piston, TC₁, is from 100 to 150 W/m° K. In some embodiments, the thermal conductivity of the insert, TC₂, is equal to or about equal to the thermal conductivity of the piston, TC₁; or TC₁=TC₂. In yet other embodiments, the thermal conductivity of the of the insert, TC₂, is less than the thermal conductivity of the piston, TC₁. In a comparative assembly having an aluminum piston/steel insert, the steel insert has a very low thermal conductivity as compared to the aluminum piston creating a thermal barrier. This results in a thermal barrier placed directly in the heat conduction pathway from the heat source, or combustion chamber, through the piston ring and into the engine block, and to the oil-cooled piston undercrown. In some embodiments, the insert material is a metal matrix composite (MMC) having a thermal conductivity from 140 to 170 W/m° K. In some embodiments, the insert material is a metal matrix composite (MMC) having a thermal conductivity of 156 W/m° K.

In some embodiments, the piston material melts as a temperature different than the insert material. In some embodiments, the melting point of the insert, MP₂, is greater than the melting point of the piston material, MP₁; or MP₂>MP₁. The piston material may have a melting point, MP₁, that is lower than that of the insert material melting point, MP₂, by a difference of from 5° C. to 200° C., or from 20° C. to 80° C. By having a higher melting point, the insert material demonstrates dimensional integrity, in other words, the insert material does not melt or deform during forming processes when integrated into the piston assembly. In some embodiments, the piston material is an aluminum alloy and has a melting temperature lower than the insert material. In some embodiments, the insert material maintains its dimensional shape above the melting temperature of the piston material. In some embodiments, the insert material maintains its dimensional shape to a temperature of up to 725° C., or to a temperature of up to 1000° C.

### Ring Groove Insert as MMC

The ring groove insert material, or second material, may be a metal matrix composite (MMC) that has at least one of the following a density from 90% to 120% of a density of the first material, a coefficient of thermal expansion from 50% to 90% of a CTE of the first material or a thermal conductivity greater than a thermal conductivity of the first material. A metal matrix composite is a composite material that includes a metal matrix and reinforcement particles dispersed in the metal matrix. The metal matrix phase is typically continuous, whereas the reinforcing particles form a dispersed phase within the metal matrix phase.

In the MMCs of the present disclosure, the matrix phase is formed from aluminum, an aluminum alloy, magnesium, a magnesium alloy, titanium, a titanium alloy, or combinations thereof. The reinforcement particles are a ceramic material selected from carbides, oxides, silicides, borides, and nitrides. Specific reinforcement particles include silicon carbide, boron carbide, titanium carbide, silicon boride, aluminum nitride, silicon nitride, titanium nitride, zirconium oxide, alumina, or combinations thereof. In particular embodiments, silicon carbide is used.

The addition of ceramic reinforcement particles to the metal matrix enables a degree of mechanical stability above the melting temperature of the matrix. This enables the solid insert material to survive the forming process without being altered or diluted.

Reinforcement particles are preferably distributed within the matrix, and may be uniformly distributed. In some embodiments, from 5 vol % to 60 vol % of reinforcement particles are dispersed within the matrix based upon the total volume of the second material. In some embodiments, the insert material is a metal matrix composite (MMC) including a matrix of an aluminum alloy and from 5 vol % to 60 vol % of reinforcement particles dispersed within the matrix based upon the total volume of the second material.

The volume fraction of reinforcement particles within the matrix based upon the total volume of the insert material. Example volume fractions may be from 5 vol % to 60 vol %, e.g. from 5 to 50 vol %, from 5 to 45 vol %, from 10 to 40 vol %, 10 to 35 vol % or from 15 to 35 vol %. In some embodiments, the MMC includes from 15 vol % to 50 vol % of the reinforcement particles based upon the total volume of the second material. In some embodiments, the MMC includes from 15 vol % to 30 vol % of the reinforcement particles based upon the total volume of the second material.

In some embodiments, the insert material maintains its dimensional shape as measured by the surface area of a first volume fraction of the metal or metal alloy matrix relative to the surface area of a second volume fraction of the reinforcement particles.

In some embodiments, the reinforcement particles have a hardness greater than the hardness of the metal matrix of the insert material. The reinforcement particles can have a hardness greater than 8 and the matrix can have a hardness less than 4, wherein hardness is measured according to the Mohs Hardness Scale. Example hardness values for the reinforcement particles may be from 8 to 10, such as from 8.0 to 8.5, from 8.0 to 9.0, from 8.0 to 9.5, from 8.0 to 10.0, from 8.5 to 9.0, from 8.5 to 9.5, from 8.5 to 10.0, from 9.0 to 9.5, from 9.0 to 10.0, or from 9.5 to 10.0. Example hardness values for the matrix may be from 2 to 5, such as from 2.0 to 2.5, from 2.0 to 3.0, from 2.0 to 3.5, from 2.0 to 4.0, from 2.0 to 4.5, from 2.0 to 5.0, from 2.5 to 3.0, from 2.5 to 3.5, from 2.5 to 4.0, from 2.5 to 4.5, from 2.5 to 5.0, from 3.0 to 3.5, from 3.0 to 4.0, from 3.0 to 4.5, from 3.0 to 5.0, from 3.5 to 4.0, from 3.5 to 4.5, from 3.5 to 5.0, from 4.0 to 4.5, from 4.0 to 5.0, or from 4.5 to 5.0. In some embodiments, the reinforcement particles have a hardness from 9 to 10 and the reinforcement particles have a hardness from 2 to 3, wherein hardness is measured according to the Mohs Hardness Scale.

As described above, the reinforcement particles may include at least one plurality of ceramic particles. The at least one plurality of reinforcement particles may include carbides, oxides, silicides, borides, nitrides, or combinations thereof. Examples of the at least one plurality of reinforcement particles include silicon carbide, boron carbide, titanium carbide, silicon boride, aluminum nitride, silicon nitride, titanium nitride, zirconium oxide, alumina, or combinations thereof. The reinforcement particles of the insert material do not melt at the melting temperature of the matrix alloy, nor do the reinforcement particles melt at the melting temperature of the first material metal or metal alloy as described above.

The reinforcement particles have a size so as to permit sufficient wear resistance at room temperature and also at operating temperatures and including at cold start-up condition temperatures of from −20° C. to 40° C. between the insert and the piston to provide for long piston life. The particle size of the reinforcement particles have a size also selected to allow non-aggressive wear resistance, which means to prevent wear within the insert or piston ring groove while also minimizing the wear of the piston ring materials.

The reinforcement particles may have an average particle size distribution (D50) in the micron range or sub-micron. The average particle size distribution is defined as the particle diameter at which a cumulative percentage of 50% by volume (vol %) of the total volume of particles are attained. In other words, 50 vol % of the particles have a diameter above the average particle size distribution, and 50 vol % of the particles have a diameter below the average particle size distribution. Without being limiting, average particle size distribution (D50) may be from 0.01 μm to 10 μm, e.g., from 0.01 μm to 5 μm, from 0.01 μm to 3.5 μm, from 0.01 μm to 3 μm, from 0.1 μm to 3 μm, from 0.5 μm to 3 μm, or from 0.9 μm to 3.0 μm. Larger coarse particles result in excessive wear on the piston wall, and thus it is preferred to use finer particles. The average particle size may be calculated by using Brunauer, Emmett and Teller (BET) equivalent spherical diameter, by laser scattering, or sieve techniques as known in the art. The reinforcement particles preferably have a spherical shape, an aspherical shape, an irregular shape, a lenticular shape, or an elongated shape. The aspect ratio of the reinforcement particles is 4:1 or less, such as 3:1 or less, 2:1 or less, 2:1 or less, or 1:1.

The reinforcement particles are devoid or substantially devoid of fibers which would have larger aspect ratios. Reinforcement fibers are unsuitable due to their lower thermal conductivity as compared with reinforcement particles having an aspect ratio of 4:1 or less.

Reinforcement particle size may also affect thermal conductivity and wear properties. Without being bound by theory, it is believed that a decrease in thermal conductivity of the MMC is observed with decreasing reinforcement particle size due to an interfacial thermal barrier at the reinforcement-matrix interface. The size of the reinforcement particles are also selected to not be too coarse, for example above 12 μm, so as to not be too aggressive on wear, i.e., wear on the piston ring.

The aluminum alloy of the insert material may be more than 88 wt % of aluminum. In some embodiments, the aluminum alloy used in the MMC is a 2000 series aluminum alloy (i.e., aluminum alloyed with copper), a 6000 series aluminum alloy (i.e., aluminum alloyed with magnesium and silicon), or a 7000 series aluminum alloy (i.e., aluminum alloyed with zinc). Non-limiting examples of suitable aluminum alloys include 2009, 2124, 2090, 2099, 6061, and 6082.

In some embodiments, the aluminum alloy of the insert material includes from 91.2 wt % to 98.6 wt % aluminum, from 0.15 wt % to 4.9 wt % copper, and from 0.1 wt % to 1.8 wt % magnesium. In a preferred embodiment, the insert material is an aluminum alloy consisting of from 0.15 wt % to 4.9 wt % copper, from 0.1 wt % to 1.8 wt % magnesium, and the balance aluminum.

In some embodiments, the aluminum alloy of the insert material includes from 91.2 wt % to 94.7 wt % aluminum, from 3.8 wt % to 4.9 wt % copper, from 1.2 wt % to 1.8 wt % magnesium, and from 0.3 wt % to 0.9 wt % manganese. In a preferred embodiment, the insert material is an aluminum alloy consisting of from 3.8 wt % to 4.9 wt % copper, from 1.2 wt % to 1.8 wt % magnesium, from 0.3 wt % to 0.9 wt % manganese, and the balance aluminum.

In some embodiments, the aluminum alloy of the insert material includes from 95.8 wt % to 98.6 wt % aluminum, from 0.8 wt % to 1.2 wt % magnesium, and from 0.4 wt % to 0.8 wt % silicon. In a preferred embodiment, the insert material is an aluminum alloy consisting of from 0.8 wt % to 1.2 wt % magnesium, from 0.4 wt % to 0.8 wt % silicon, and the balance aluminum.

In some embodiments, the aluminum alloy of the insert material includes from 92.8 wt % to 95.8 wt % aluminum, from 3.2 wt % to 4.4 wt % copper, from 0 to 0.2 wt % iron, from 1.0 to 1.6 wt % magnesium, from 0 to 0.6 wt % oxygen, from 0 to 0.25 wt % silicon, and from 0 to 0.25 wt % zinc. In a preferred embodiment, the insert material is an aluminum alloy consisting of from 3.2 wt % to 4.4 wt % copper, from 0 to 0.2 wt % iron, from 1.0 to 1.6 wt % magnesium, from 0 to 0.6 wt % oxygen, from 0 to 0.25 wt % silicon, from 0 to 0.25 wt % zinc, and the balance aluminum.

In some particular embodiments, an MMC insert material includes 6061 series or 2124 series aluminum alloy reinforced with 10 vol % to 50 vol % of silicon carbide particles, including from 15 vol % to 30 vol % and from 30 vol % to 50 vol % of silicon carbide particles.

The insert material, or second material, which may include a metal matrix composite (MMC) as described above may be a preformed solid, which is dense and can be characterized as having minimal porosity. This low porosity is maintained from the preform insert to being further subjected to piston forming processes so that the insert in integrally formed with the piston to form a piston assembly. Example low porosity values for the insert material may be from less than or equal to 5%, e.g., less than or equal to 2.5%, less than or equal to 2%, less than or equal to 1.5%, less than or equal to 1%, or less than or equal to 0.5%. In some embodiments, the ring groove insert has a porosity of less than or equal to 0.5%. Low porosity may reduce the infiltration of the first material during casting into the metal matrix composite. Ring groove insert formed from materials with a low porosity provide a preformed solid.

Prior to forming the piston assembly, the inner surface of the ring groove insert (such as surface 370 of the ring groove insert of FIG. 3B and FIG. 3C) may have a surface roughness (Ra) of 0.4 μm or more. Example surface roughness values for the inner surface of the insert material may be from 0.2 μm to 1.6 μm, such as from 0.2 μm to 0.4 μm, from 0.2 μm to 0.8 μm, from 0.2 μm to 1.6 μm, from 0.4 μm to 0.8 μm, from 0.4 μm to 1.6 μm, or from 0.8 μm to 1.6 μm. In some embodiments, the surface roughness (Ra) is 0.4 μm or more. The inner surface of the ring groove insert may be altered to increase or decrease the surface roughness as needed by methods known in the art prior to the preform insert being processed with the piston to form the piston assembly. Surface roughness can be altered by grinding, honing, machining, shot blasting, aqua blasting, grit or bead blasting, among other surface preparation methods. Surface roughness is measured by surface profilometry.

### Piston Assembly Interfacial Region

The insert may contact the piston directly without a coating or indirectly with a coating to form an interface. Any suitable coating may be applied as thin films, foils, by plating, anodizing, cold spraying, electrolysis, flashing, or combinations thereof. The insert may be “flashed” as known in the art, e.g., dipped into molten metal, prior to casting or forging. The molten metal for flashing may include aluminum, silicon, copper, manganese, magnesium, iron, zinc, nickel, scandium, lithium, titanium, zirconium, tin, or combinations thereof. Without being bound by theory, it is believed that the insert being flashed prior to casting with the piston, for example, provides for sufficient bonding with the piston, via an interfacial region, so that the ring groove insert does not de-bond or delaminate from the piston.

In some embodiments, the piston assembly as described herein further includes an interfacial region between the inner surface of the ring groove insert and the piston head (e.g., inner surface 370 of the ring groove insert of FIG. 3B and FIG. 3C bonded directly or indirectly to the piston circumferential groove 330).

Upon forming the piston assembly, the inner surface of the ring groove insert in contact with the piston circumferential groove 330 is non-anodized being devoid or substantially devoid of oxides. In some embodiments, the piston assembly has an aluminum oxide to aluminum ratio of less than or equal to 1/1000 at the interface of the insert and the piston.

The reinforcement particles do not migrate to the interface but rather stay dispersed within the MMC of the insert due to the microstructural stability of the insert material to withstand thermomechanical processes during forming and/or subsequent thermal treatments with the piston. In some embodiments, the insert material is a metal matrix composite (MMC) including an aluminum alloy and from 5 vol % to 60 vol % of reinforcement particles, wherein the interfacial region has a ratio of reinforcement particles to matrix phase of less than or equal to 1/500.

The interfacial region may include at least one intermetallic secondary phase. The intermetallic secondary phases may include aluminum, silicon, copper, manganese, magnesium, iron, zinc, nickel, scandium, lithium, titanium, zirconium, tin, or combinations thereof.

Bonding at the interface of the insert and piston is critical for performance, long life, and wear resistance. Porosity and/or gaps are deleterious and are to be avoided. To achieve maximum contact between the insert and the piston, forming processes as well as subsequent heat treatments are contemplated. In some embodiments, the interfacial region has a porosity of less than or equal to 5%, less than or equal to 4%, less than or equal to 3%, less than or equal to 2%, less than or equal to 1%, or less than or equal to 0.5%. In some embodiments, the interfacial region has a porosity of less than or equal to 0.5%.

A diffusion control coating may optionally be utilized at the interface between the insert and the piston. In some embodiments, the interfacial region includes a diffusion control coating separating the first material of the piston and the second material of the insert. The interfacial region may include a diffusion control coating to prevent alloying elements from the piston metal or metal alloy from migrating. The diffusion control coating may include aluminum, copper, nickel, zinc, or combinations thereof. The coating may be applied to the inner surface of the ring groove insert prior to forming processes to integrate with the piston into the piston assembly. In some embodiments, the interfacial region includes at least one intermetallic secondary phase including aluminum, copper, nickel, zinc, or combinations thereof. In some embodiments, the interfacial region is enriched in one or more alloying elements of copper, manganese, magnesium, iron, zinc, or nickel migrating from a first aluminum alloy of the piston head. In some embodiments, the interfacial region is enriched with at least one of magnesium and nickel.

### Methods of Forming Inserts

The insert material according to the present disclosure can be formed into the insert ring having at least one groove for receiving a piston ring by various methods known in the art. Thus, ring groove insert preferably is a preformed solid. The ring groove insert has a density from 2.5 g/cm³ to 3.0 g/cm³, a thermal conductivity from 140 to 170 W/m° K, a CTE from 15 ppm/° C. to 25 ppm/° C., and a porosity of less than or equal to 0.5%.

Methods of forming the ring groove insert include, but are not limited to, pressing and sintering of powder, hot powder pressing, pressing and forging, forging of either a solid or powder preform, direct and indirect extrusion, stamping or coining from a rolled sheet, and/or machining from a preformed solid.

The shape is generally ring shaped as shown in FIG. 3B. Methods of forming the ring groove insert may further include modifying the surface. Surface modification includes altering or eliminating any corners to provide rounded, chamfered, sinusoidal, or scalloped surfaces on the ring groove insert. The inner surface of the ring groove insert that is in contact with or otherwise enveloped by the piston casting (e.g., surface 370 including 370A and 370B as in FIG. 3C), includes a rounded, chamfered, sinusoidal, or scalloped surface. The insert shape may be modified as such to enhance bonding between the insert and the piston, i.e., to provide bonding without gaps or introducing porosity.

Other methods of modifying the shape of the ring groove insert may include, additionally or alternatively, adding features such as through holes or protrusions to facilitate improved bonding between the insert and the piston. For example, the ring groove insert may be machined to drill holes through the circumferential thickness of the ring groove insert thereby allowing some of the piston material to penetrate the insert ring during forming the piston assembly. Additionally or alternatively, protrusions or pin features may be included in the ring groove insert by sintering a powder preformed shape or by machining.

In some embodiments, the surface and more particularly the inner surface of the ring groove insert is modified to improve adhesion and thermal conductivity by increasing the surface area. Surface area of the inner surface may be increased by at least one of adding grooves on the surface of various period and amplitude and/or roughening the surface to tailor the surface roughness (Ra).

Methods of forming the ring groove insert may further include coating the ring groove insert, as previously described, before die casting or forging the piston around the insert. Coatings are used to promote adhesion between the cast material and the insert. Coatings may range in thickness from a few nanometers to several microns. The coatings may be applied as thin films, foils, by plating, anodizing, cold spraying, electrolysis, flashing, or combinations thereof. Without being limiting, the coating thickness may be from 0.01 μm to 5.0 μm, e.g., from 0.01 μm to 4 μm, from 0.01 μm to 3.5 μm, from 0.01 μm to 3 μm, from 0.1 μm to 3 μm, from 0.5 μm to 3 μm, or from 1.0 μm to 3.0 μm.

The above methods including shape modification, surface modification, and/or coating may be performed prior to integrating the preformed solid ring groove insert with the piston as described below to form the piston assembly.

### Methods of Making Piston Assemblies

Methods of making the piston assembly include providing the ring groove insert as described above, where the insert may be a preformed solid. Manufacturing processes as known using conventional steel inserts with aluminum pistons are applicable to the embodiments herein. The preformed solid ring groove insert may then be die cast or forged with the piston material metal or metal alloy, or first material as described herein, to form around the preformed solid ring groove insert. The piston assembly including the piston and the ring groove insert may include casting or forging. Forming the piston assembly may be performed at or above the solidus temperature of the piston metal or metal alloy. In preferred embodiments, casting is performed at or above the solidus temperature of the piston metal or metal alloy to form a cast piston assembly. Other methods are also contemplated such as gravity, low and high pressure die casting, squeeze casting, thixoforging, semi-solid forging, and additive manufacturing. Additive manufacturing could be used to form the piston up to the insert, place the insert into the powder, and then continue additive manufacturing to complete the integration into the monolithic piston/insert unit.

Methods of making the piston assembly may further include at least one of homogenizing, quenching, ageing, and heat treating the piston assembly after die casting or other forming technique to form the piston assembly. Methods of making the piston assembly include forming at least one ring groove in the ring groove for receiving at least one piston ring. The at least one ring groove (e.g., groove 390 in FIG. 3C) may be machined into the insert (e.g., insert 360 in FIG. 3C) at any time after forming the piston assembly.

In the example of casting the piston material to form the piston assembly including the ring groove insert, the methods disclosed herein may include adding different alloying elements (such as aluminum, silicon, copper, manganese, magnesium, iron, zinc, nickel, scandium, lithium, titanium, zirconium, or tin) to the master alloy or pure metal (aluminum, aluminum alloy, magnesium, magnesium alloy, or combinations thereof) to the molten liquid pool. This also may involve stirring the furnace using magnets or manual stirring. The methods disclosed herein may include using an induction furnace or a gas fire furnace or an electric resistance furnace for preparing the molten liquid.

The methods disclosed herein may include casting a molten aluminum alloy to form an aluminum alloy cast piston having a ring groove insert. In some embodiments, the molten alloy may be treated before casting. The treatment can include one or more of furnace fluxing, inline degassing, inline fluxing, and filtering. Aluminum alloy cast pistons can be formed using any casting process performed according to standards commonly used in the aluminum industry as known to one of ordinary skill in the art, including by direct casting and continuous casting methods. As a few non-limiting examples, casting processes may include a direct chill (DC) casting process or a permanent mold process. In some aspects, DC casting is used.

The methods disclosed herein may include homogenization. Homogenization may include heating a cast piston assembly prepared from an alloy composition described herein to attain a peak metal temperature (PMT) of at least 400° C. (e.g., at least 400° C., at least 410° C., at least 420° C., at least 430° C., at least 440° C., at least 450° C., at least 460° C., at least 470° C., at least 480° C., at least 490° C., at least 500° C., at least 510° C., at least 520° C., or at least 530° C.). For example, the aluminum alloy piston assembly can be heated to a temperature of from 400° C. to 580° C., from 420° C. to 575° C., from 440° C. to 570° C., from 460° C. to 565° C., from 485° C. to 560° C., from 500° C. to 560° C., or from 520° C. to 580° C. Optionally, the heating rate to the PMT is 100° C./hour or less, 75° C./hour or less, 50° C./hour or less, 40° C./hour or less, 30° C./hour or less, 25° C./hour or less, 20° C./hour or less, or 15° C./hour or less. Optionally, the heating rate to the PMT is from 10° C./min to 100° C./min (e.g., 10° C./min to 90° C./min, 10° C./min to 70° C./min, 10° C./min to 60° C./min, from 20° C./min to 90° C./min, from 30° C./min to 80° C./min, from 40° C./min to 70° C./min, or from 50° C./min to 60° C./min).

In some instances, the aluminum alloy cast piston assembly is then allowed to soak (i.e., held at a particular temperature, such as a PMT) for a period of time. In some embodiments, the aluminum alloy cast piston assembly is allowed to soak for up to 24 hours (e.g., from 30 minutes to 6 hours, inclusively). For example, in some embodiments, the aluminum alloy piston assembly is soaked at a temperature of at least 400° C. for 30 minutes or more (e.g., up to 24 hours). Homogenization as described herein can be carried out in a multi-stage homogenization process. In some embodiments, the homogenization process can include two or more stages of homogenization heating and soaking cycles.

After homogenization, a quenching water can be applied on the surface of the piston assembly for few second so that the outer surface cools faster and maintaining the inner surface at a higher temperature, which may also promote a gradient in microstructure across the cross-section. A gradient in microstructure may include at least one of a gradient in chemical composition, primary grains distribution, insoluble intermetallic particles (type, size, shape, distribution), texture, or the distribution of recrystallized grains, strengthening precipitates, and/or reinforcement particles.

In some embodiments, the piston assembly can then be cooled to room temperature at a quench rate that can vary between 50° C./s to 400° C./s in a quenching step that is based on the selected gauge. For example, the quench rate can be from 50° C./s to 375° C./s, from 60° C./s to 375° C./s, from 70° C./s to 350° C./s, from 80° C./s to 325° C./s, from 90° C./s to 300° C./s, from 100° C./s to 275° C./s, from 125° C./s to 250° C./s, from 150° C./s to 225° C./s, or from 175° C./s to 200° C./s.

In the quenching step, the aluminum alloy piston assembly is rapidly quenched with a liquid (e.g., water) and/or gas or another selected quench medium. In certain aspects, the aluminum alloy piston assembly can be rapidly quenched with water. In some embodiments, the aluminum alloy piston assembly is quenched with air.

In some embodiments, the aluminum alloy piston assembly can be artificially aged for a period of time, such as being artificially aged to result in the T6 or T7 temper. In some embodiments, to accelerate the hardening process the aluminum alloy piston assembly can be artificially aged at 100° C. to 225° C. for a period of time. Optionally, the aluminum alloy piston assembly can be artificially aged for a period from 15 minutes to 48 hours. Multiple aging treatments can also be used.

In some embodiments, a heat treatment during or after production can also be applied to produce the aluminum alloy piston assembly for improved bonding in the interfacial region as described above. In some embodiments, the aluminum alloy piston assembly can be heat treated at from 400° C. to 600° C. for a period of time. Optionally, the aluminum alloy piston assembly can be heat treated for a period from 15 minutes to 48 hours. In certain aspects, the piston assembly is heat treated at 500° C. for 24 hours.

### Methods of Forming Piston Assemblies by Forging

Piston assemblies may be formed by hot forging in suitable tooling at temperatures from 300° C. to 550° C., and more preferably at temperatures from 400° C. to 500° C.

The following examples are provided to illustrate the compositions, articles, and methods of the present disclosure. The examples are merely illustrative and are not intended to limit the disclosure to the materials, conditions, or process parameters set forth therein.

### EXAMPLES

### Example 1

A ring groove insert was prepared according to aspects of the disclosure herein. The insert material [SupremEX® 225CA Alloy (MATERION PERFORMANCE ALLOYS AND COMPOSITES, Mayfield Heights, Ohio 44124, USA)] included a high-quality aluminum alloy (2124A) reinforced with 25 vol. % silicon carbide particles to produce a metal matrix composite (MMC). The silicon carbide have an average particle size distribution (D50) of 3 μm. Physical properties of 2124 aluminum alloy reinforced with 25 vol % silicon carbide particles are shown in Table 1.

TABLE 1
Physical Properties

| | |
|---|---|
| Density, g/cm³ (lbs/in³ ) | 2.88 (0.104) |
| Elastic Modulus, GPa (msi) | 115 (16.7) |
| Specific Stiffness, GPa/g/cm³ | 39 |
| Poisson's Ratio | 0.3 |
| Thermal Conductivity @ 25° C. | 156 (90) |
| W/m° K. (BTU/hr · ft. ° F.) | |
| Thermal Expansion @ 25° C. ppm/° C. (ppm/° F.) | 16.3 (9.1) |
| Solidus ° C. (° F.) | 548 (1018) |
| Specific Heat Capacity J/g/° C. (BTU/lb/° F.) | 0.829 (0.198) |

The insert material was manufactured via a powder metallurgy route using a mechanical alloying process. The resultant microstructure demonstrated a homogeneous distribution of reinforcement particles and a refined grain structure. The insert material properties include a density of 2.88 g/cm³, an elastic modulus of 115 GPa, a coefficient of thermal expansion of 16.1 μm/mK, and a thermal conductivity (TCᵢₙₛₑᵣₜ) of 156 W/m° K.

The piston assembly was formed by casting a piston material aluminum alloy including 12.6 wt % silicon (Al-12.6Si) around the ring groove insert. The Al-12.6Si alloy forming the piston has a density of 2.68 g/cm³, a coefficient of thermal expansion (CTE) of 18.0 μm/m K, and a thermal conductivity of 154 W/m° K.

The density of the insert material (2.88 g/cm³) is 107% of the density of the piston material (2.68 g/cm³). In addition, the insert material has a significantly lower density than steel. The coefficient of thermal expansion of the insert material (16.1 μm/mK) is 89% of the CTE of the piston material (18.0 μm/mK) that reduces the bond stress between the insert and piston. The thermal conductivity of the insert material (156 W/m° K) is greater than the thermal conductivity of the piston material (154 W/m° K) and provides improved cooling to the piston by reducing thermal barriers.

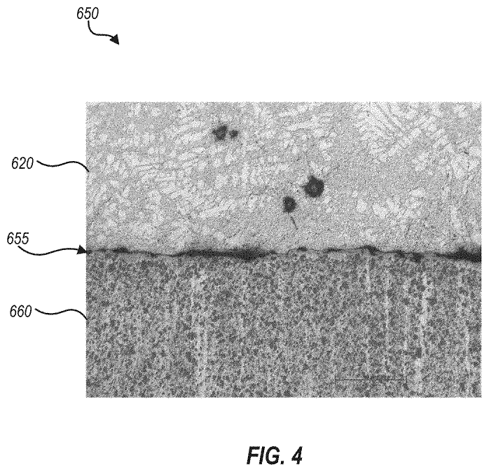

FIG. 4 is a scanning electron micrograph of the interfacial region 655 of piston assembly 650 having piston 620 and insert 660.

### Example 2

A preformed solid ring groove insert was prepared as in Example 1. The insert inner surface was then plated with copper to form a diffusion barrier coating, 2 μm in thickness, and to enhance bonding of the insert to the piston.

The piston assembly was formed by casting the piston material aluminum alloy, Al-12.6Si, including 12.6 wt % silicon around the preformed solid ring groove insert as in Example 1.

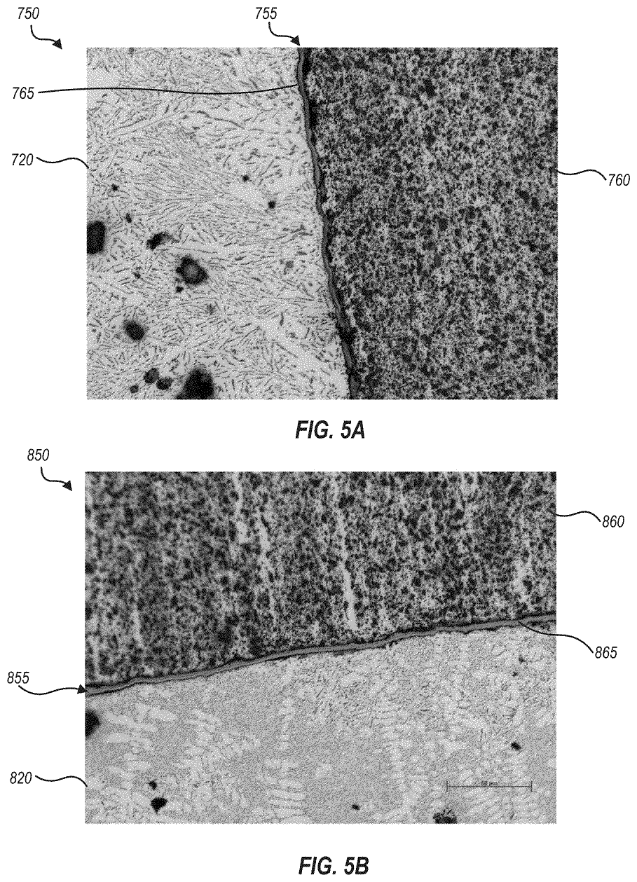

FIG. 5A is a scanning electron micrograph of the interfacial region 755 of piston assembly 750 having piston 720 and insert 760. Interfacial region 755 includes a copper layer 765 between the piston and the insert.

### Example 3

A preformed solid ring groove insert was prepared as in Example 1. The insert inner surface was then plated with nickel/copper to form a diffusion barrier coating, 2 μm in thickness, and to enhance bonding of the insert to the piston.

The piston assembly was formed by casting a piston material aluminum alloy including 12.6 wt % silicon around the preformed solid ring groove insert as in Example 1.

FIG. 5B is a scanning electron micrograph of the interfacial region 855 of piston assembly 850 having piston 820 and insert 860. Interfacial region 855 includes a nickel/copper layer 865 between the piston and the insert.

### Example 4

A piston assembly was formed as in Example 3. The assembly was then heat treated at 500° C. for 24 hours.

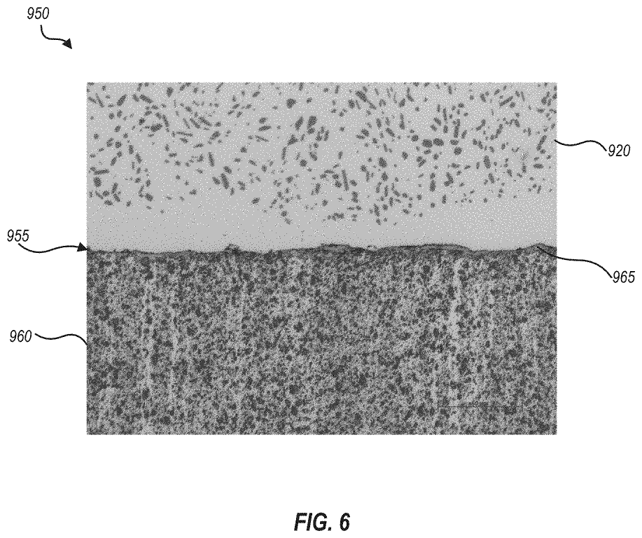

FIG. 6 is a scanning electron micrograph of the interfacial region 955 of piston assembly 950 having piston 920 and insert 960. Interfacial region 955 includes a nickel/copper layer 965 between the piston and the insert. The interface demonstrates good bonding. Using scanning electron microscopy (SEM) and energy dispersive X-ray spectroscopy (EDS), it was observed that the silicon content of the piston casting is locally reduced and that a significant magnesium presence had migrated unexpectedly to the interface.

### Example 5

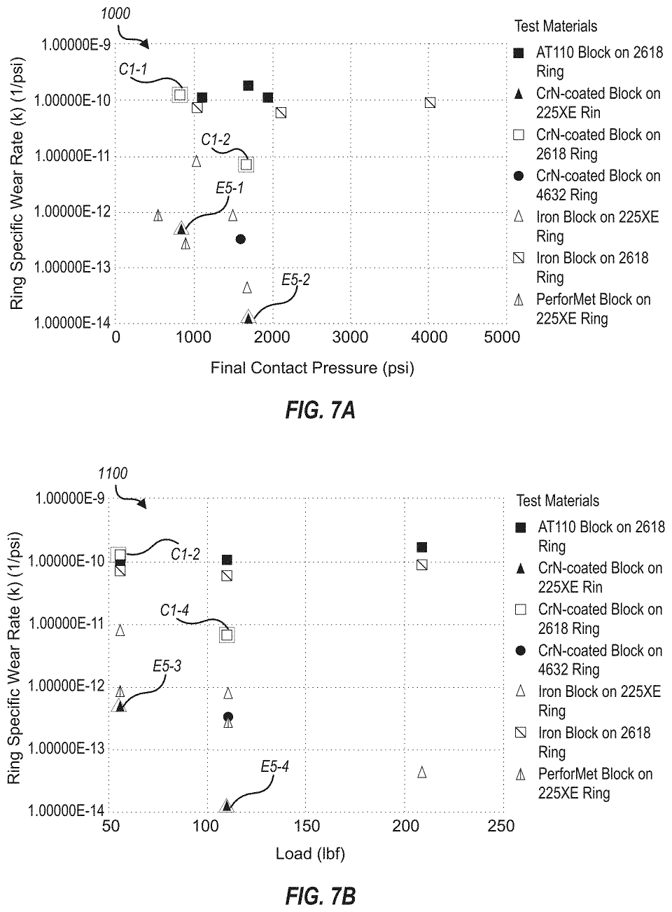

FIG. 7A illustrates plot 1000 showing ring specific wear rate (k)(1/psi) as a function of final contact pressure (psi) for various materials to measure wear. Example 5 is a CrN coated block on the insert ring and includes data shown as plot points E5-1 and E5-2 for the insert material [SupremEX® 225XE Alloy (MATERION PERFORMANCE ALLOYS AND COMPOSITES, Mayfield Heights, Ohio 44124, USA)] including a high-quality aerospace grade aluminum alloy (2124A) reinforced with 25 vol. % silicon carbide particles to produce a metal matrix composite (MMC), and having the physical properties below as shown in Table 2.

TABLE 2
Physical Properties

| | |
|---|---|
| Density, g/cm³ (lbs/in³ ) | 2.88 (0.104) |
| Elastic Modulus, GPa (msi) | 115 (16.7) |
| Specific Stiffness, GPa/g/cm³ | 39 |
| Poisson's Ratio | 0.3 |
| Thermal Conductivity @ 25° C. | 150 (87) |
| W/m° K. (BTU/hr · ft. ° F.) | |
| Thermal Expansion @ 25° C. ppm/° C. (ppm/° F.) | 16.1 (8.9) |
| Solidus ° C. (° F.) | 548 (1018) |
| Specific Heat Capacity J/g/° C. (BTU/lb/° F.) | 0.836 (0.200) |

Comparative Example C1, includes data shown as plot points C1-1 and C1-2, uses the same CrN block material as for Example 5 but on AA2618 rings to represent a conventional steel insert (coated with CrN) against a forged alloy AA2618 and having a similar wear rate to the cast aluminum piston materials. As shown, Example 5 demonstrates at least a 500× lower wear rate than for the comparative material.

FIG. 7B illustrates plot 1100 showing ring specific wear rate (k)(1/psi) as a function of load (lbf). Example 5 includes data shown as plot points E5-3 and E5-4 and Comparative Example C1 includes data shown as plot points C1-3 and C1-4. Again, Example 5 demonstrates a significantly lower wear rate than the steel comparative material.

### Example 6

Pin on Discs Wear Test according to ASTM G99 were performed for various materials including the insert material as in Example 5 to measure the weight loss on pin and disc. The parameters for the Pin on Discs Wear Test were as shown in Table 3.

TABLE 3
Pin on Disc Testing Parameters
⅜″ (9.525 mm) Dia Pins on 1.5″ Dia Disc
Pin Material: 4340 Steel, ground finish.
Lab Conditions 23° C., 36% RH.
Wear Cycle Frequency 2 Hz
Wear Pattern 15 mm Unidirectional Path
Load: 20, 35, 50N.
Discs-Testing Various materials, machined finish.
Test Duration 5000 cycles (65N), 10000 cycles (50, 35 & 20N load)
Contact Area 71.26 mm2

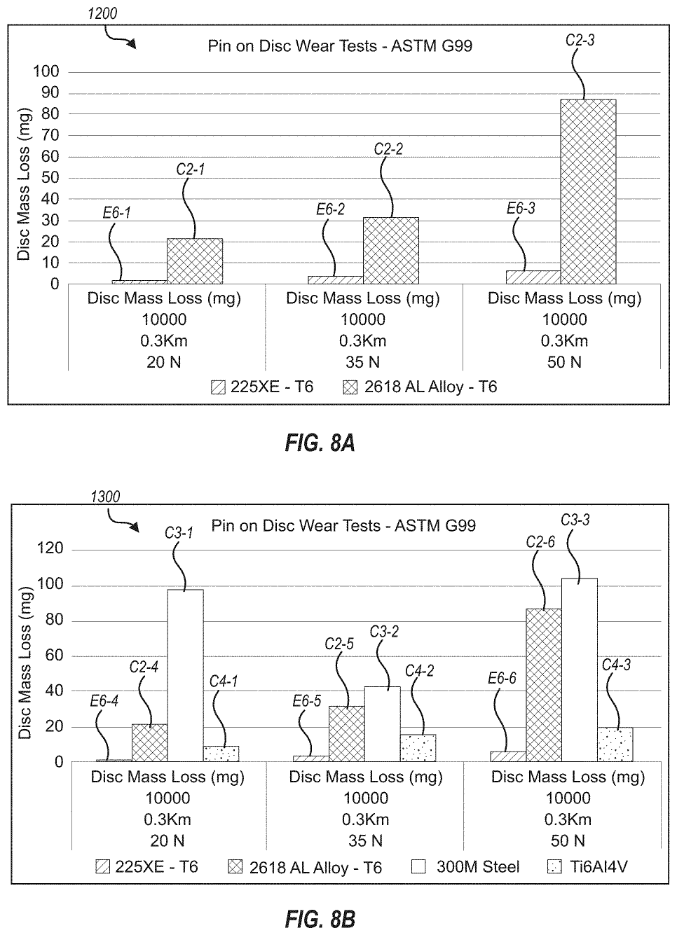

FIG. 8A includes plot 1200 showing data for the disc loss vs steel pin for Example 6, including the insert material as in Example 5, and for Comparative Ex. C2, a 2618 aluminum alloy, at 20 N, 35 N, and 50 N. Example 6 demonstrates at weight loss that is about one tenth of that of the 2618 aluminum alloy.

FIG. 8B includes plot 1300 showing data for the disc loss vs steel pin for Example 6, Comparative Ex. C2, as well as for Comparative Ex. C3, 300M Steel and Comparative Ex. C4, Ti6Al4C titanium alloy, at 20 N, 35 N, and 50 N. Example 6 demonstrates weight loss significantly lower than that of the comparatives.

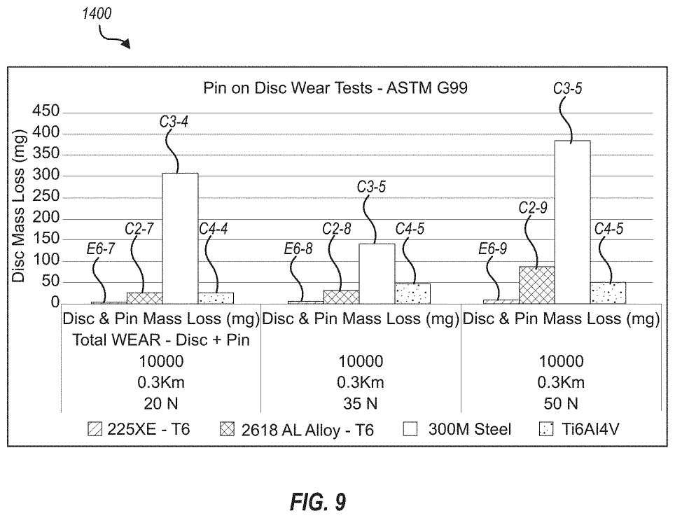

FIG. 9 includes plot 1400 showing data for the combined steel pin loss and disc loss (by sides of the wear couple) vs discs for Example 6 and Comparative Examples C2, C3, and C4 at 20 N, 35 N, and 50 N. Example 6 demonstrates weight loss significantly lower than that of the comparatives.

### Example 7

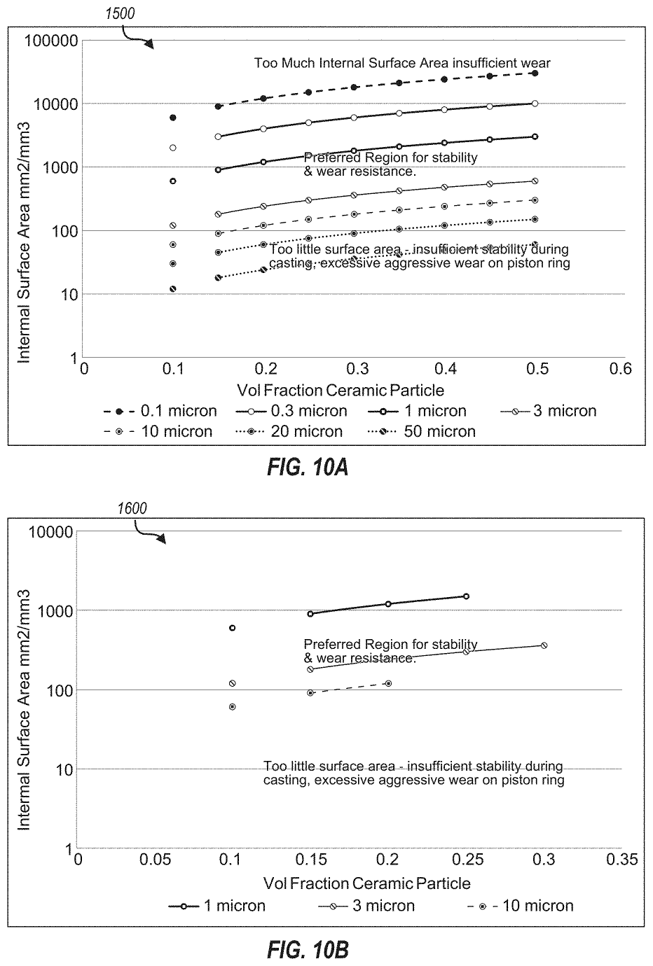

FIG. 10A includes plot 1500 showing the internal surface area (mm²/mm³) of the matrix of the MMC insert material as a function of the volume fraction of ceramic particles (from 10 vol % to 50 vol %) within the matrix of the insert material for ceramic particles having an average particle size distribution of from 0.1 μm to 50 μm.

FIG. 10B includes plot 1600 showing the preferred region of internal surface area (mm²/mm³) of the matrix of the MMC insert material as a function of the volume fraction of ceramic particles from 10 vol % to 30 vol % using ceramic particles having an average particle size distribution of from 1.0 μm to 10 μm. Plots 1500 and 1600 theoretically predict the preferred region for stability and wear resistance within the MMC by balancing particle size and volume fraction of ceramic particles within the matrix. An internal surface area too high provides for insufficient wear, and an internal surface area too low provides for insufficient stability during casting and excessive aggressive wear on a piston ring during operation.

### Example 8

Accelerated Durability Testing was performed on MMC ring groove inserts prepared as in Example 1. This testing was modeled after the standard Ford 150-hour test (96 hours at wide open throttle). The modified test used a Ford 2.3 L EcoBoost as the base engine. Due to material selection, the total mass of the piston, pin, and rod was reduced by 30% (1.4 kg) as compared with conventional engine materials. The test procedure for the 150 hour Accelerated Durability Test included repeated 40 minute cycles. Each cycle included idle (at 2000 rpm), peak torque (at 3000 rpm), peak power (at 6000 rpm), and 90% e-max (peak power with reduced speed at 5850 rpm). The 40 minute cycles were repeated 225 times for a total of 150 hours. See summary in Table 4. Therefore, this aggressive testing included the engine spending over 96 hours at 90% or greater WOT (wide-open throttle). The head gasket was blown twice during testing indicating the hard running during testing. This failure of head gaskets demonstrates the intensity of the testing regime.

TABLE 4
Accelerated Durability Testing

| | minutes |
|---|---|
| Run Time Required for Cycle | 9000 |
| Total WOT required for Cycle | 5625 |
| Total Running During Break-In/Shakedown | 1431.2 |
| Total WOT Running During Break-In/Shakedown | 184.01 |
| Total Running on Cycle (including warm-ups) | 10431.2 |
| Total Running WOT on Cycle | 5628.36 |
| Combined Running | 11862.3 |
| Combined WOT Running | 5812.37 |

Even with the severe conditions of the Accelerated Durability Testing, there was no indication of wear of the MMC ring groove inserts. And, any dimensional change for the entire piston assembly was minimal. While the piston grooves demonstrated a dimensional change in top groove flatness, increasing from an average of 15 microns to an average of 42 microns over the course of the test, this was minimal. Importantly, the results demonstrated consistent engine performance throughout the testing with no appreciable wear or deformation of the MMC ring groove inserts.

### EMBODIMENTS

The following embodiments are contemplated. All combinations of features and embodiments are contemplated.

Embodiment 1: A piston assembly comprising: a piston having a circumferential groove; and a ring groove insert within the circumferential groove of the piston, wherein the ring groove insert has an outer surface and an inner surface, wherein the ring groove insert is a second material different from a first material of the piston, wherein the second material has at least one of the following:
a) a density from 90% to 120% of a density of the first material;
b) a coefficient of thermal expansion (CTE) from 50% to 90% of a CTE of the first material; or
c) a thermal conductivity greater than a thermal conductivity of the first material.

Embodiment 2: An embodiment of embodiment 1, wherein the first material is aluminum, aluminum alloy, magnesium, magnesium alloy, or combinations thereof.

Embodiment 3: An embodiment of embodiment 1 or 2, wherein the aluminum alloy includes one or more alloying elements of silicon, copper, manganese, magnesium, iron, zinc, nickel, scandium, lithium, titanium, zirconium, or tin.

Embodiment 4: An embodiment of any of the embodiments of embodiment 1-3, wherein the aluminum alloy has a melting temperature different than the second material within a differential from 20° C. to 80° C.

Embodiment 5: An embodiment of any of the embodiments of embodiment 1-4, wherein the aluminum alloy of the first material has a melting temperature lower than the second material.

Embodiment 6: An embodiment of any of the embodiments of embodiment 1-5, wherein the second material maintains its dimensional shape above the melting temperature of the first material.

Embodiment 7: An embodiment of any of the embodiments of embodiment 1-6, wherein the second material maintains its dimensional shape to a temperature of up to 725° C.

Embodiment 8: An embodiment of any of the embodiments of embodiment 1-7, wherein the second material maintains its dimensional shape to a temperature of up to 1000° C.

Embodiment 9: An embodiment of any of the embodiments of embodiment 1-8, wherein the second material is a metal matrix composite (MMC) including a matrix of aluminum, aluminum alloy, magnesium, magnesium alloy, titanium, titanium alloy, or combinations thereof and from 5 vol % to 60 vol % of reinforcement particles dispersed within the matrix based upon the total volume of the second material.

Embodiment 10: An embodiment of any of the embodiments of embodiment 1-9, wherein the second material is a metal matrix composite (MMC) including a matrix of an aluminum alloy and from 5 vol % to 60 vol % of reinforcement particles dispersed within the matrix based upon the total volume of the second material.

Embodiment 11: An embodiment of any of the embodiments of embodiment 1-10, wherein the reinforcement particles have a hardness greater than the hardness of the matrix.

Embodiment 12: An embodiment of any of the embodiments of embodiment 1-11, wherein the reinforcement particles have a hardness greater than 8 and the matrix has a hardness less than 4, wherein hardness is measured according to the Mohs Hardness Scale.

Embodiment 13: An embodiment of any of the embodiments of embodiment 1-12, wherein the reinforcement particles have a hardness from 9 to 10 and the matrix has a hardness from 2 to 3, wherein hardness is measured according to the Mohs Hardness Scale.

Embodiment 14: An embodiment of any of the embodiments of embodiment 1-13, wherein the reinforcement particles include at least one plurality of ceramic particles.

Embodiment 15: An embodiment of any of the embodiments of embodiment 1-14, wherein the at least one plurality of reinforcement particles include carbides, oxides, silicides, borides, nitrides, or combinations thereof.

Embodiment 16: An embodiment of any of the embodiments of embodiment 1-15, wherein the at least one plurality of reinforcement particles include silicon carbide, boron carbide, titanium carbide, silicon boride, aluminum nitride, silicon nitride, titanium nitride, alumina, or combinations thereof.

Embodiment 17: An embodiment of any of the embodiments of embodiment 1-16, wherein the MMC includes from 15 vol % to 50 vol % of the reinforcement particles based upon the total volume of the second material.

Embodiment 18: An embodiment of any of the embodiments of embodiment 1-17, wherein the MMC includes from 15 vol % to 30 vol % of the reinforcement particles based upon the total volume of the second material.

Embodiment 19: An embodiment of any of the embodiments of embodiment 1-18, wherein the MMC has a thermal conductivity from 140 to 170 W/m° K.

Embodiment 20: An embodiment of any of the embodiments of embodiment 1-19, wherein the average particle size of the reinforcement particles is from 0.01 μm to 10 μm.

Embodiment 21: An embodiment of any of the embodiments of embodiment 1-20, wherein the aluminum alloy of the second material is more than 88 wt % of aluminum.

Embodiment 22: An embodiment of any of the embodiments of embodiment 1-21, wherein the aluminum alloy of the second material includes from 91.2 wt % to 98.6 wt % aluminum, from 0.15 wt % to 4.9 wt % copper, and from 0.1 wt % to 1.8 wt % magnesium.

Embodiment 23: An embodiment of any of the embodiments of embodiment 1-22, wherein the aluminum alloy of the second material includes from 91.2 wt % to 94.7 wt % aluminum, from 3.8 wt % to 4.9 wt % copper, from 1.2 wt % to 1.8 wt % magnesium, and from 0.3 wt % to 0.9 wt % manganese.

Embodiment 24: An embodiment of any of the embodiments of embodiment 1-23, wherein the aluminum alloy of the second material includes from 95.8 wt % to 98.6 wt % aluminum, from 0.8 wt % to 1.2 wt % magnesium, and from 0.4 wt % to 0.8 wt % silicon.

Embodiment 25: An embodiment of any of the embodiments of embodiment 1-24, wherein the aluminum alloy of the second material includes from 92.8 wt % to 95.8 wt % aluminum, from 3.2 wt % to 4.4 wt % copper, from 0 to 0.2 wt % iron, from 1.0 to 1.6 wt % magnesium, from 0 to 0.6 wt % oxygen, from 0 to 0.25 wt % silicon, and from 0 to 0.25 wt % zinc.

Embodiment 26: An embodiment of any of the embodiments of embodiment 1-25, wherein the second material maintains its dimensional shape as measured by the surface area of a first volume fraction of the another aluminum alloy matrix relative to the surface area of a second volume fraction of the reinforcement particles.

Embodiment 27: An embodiment of any of the embodiments of embodiment 1-26, wherein the inner surface of the ring groove insert has an aluminum oxide to aluminum ratio of less than or equal to 1/1000.

Embodiment 28: An embodiment of any of the embodiments of embodiment 1-27, wherein the inner surface of the ring groove insert has a surface roughness (Ra) of 0.4 μm or more.

Embodiment 29: An embodiment of any of the embodiments of embodiment 1-28, wherein the ring groove insert has a porosity of less than or equal to 0.5%.

Embodiment 30: An embodiment of any of the embodiments of embodiment 1-29, wherein the ring groove insert comprises one or more grooves extending inward from the outer surface.

Embodiment 31: An embodiment of any of the embodiments of embodiment 1-30, wherein a portion of the ring groove insert extends into the top land of the piston, wherein a distance measured from the top of the uppermost one or more grooves to the top of the piston is reduced by at least 10% compared with a reference steel insert.

Embodiment 32: An embodiment of any of the embodiments of embodiment 1-31, further including an interfacial region between the inner surface of the ring groove insert and the piston.

Embodiment 33: An embodiment of any of the embodiments of embodiment 1-32, wherein the interfacial region includes at least one intermetallic secondary phase.

Embodiment 34: An embodiment of any of the embodiments of embodiment 1-33, wherein the interfacial region includes a diffusion control coating separating the first material and the second material.

Embodiment 35: An embodiment of any of the embodiments of embodiment 1-34, wherein the interfacial region includes a coating of aluminum, copper, nickel, or zinc.

Embodiment 36: An embodiment of any of the embodiments of embodiment 1-35, wherein the interfacial region includes at least one intermetallic secondary phase including aluminum, copper, nickel, zinc, or combinations thereof.

Embodiment 37: An embodiment of any of the embodiments of embodiment 1-36, wherein the interfacial region is enriched in one or more alloying elements of copper, manganese, magnesium, iron, zinc, or nickel migrating from a first aluminum alloy of the piston.

Embodiment 38: An embodiment of any of the embodiments of embodiment 1-37, wherein the interfacial region is enriched with at least one of magnesium and nickel.

Embodiment 39: An embodiment of any of the embodiments of embodiment 1-38, wherein the second material is a metal matrix composite (MMC) including an aluminum alloy and from 5 vol % to 60 vol % of reinforcement particles, wherein the interfacial region has a ratio of reinforcement particles to matrix phase of less than or equal to 1/500.

Embodiment 40: An embodiment of any of the embodiments of embodiment 1-39, wherein the interfacial region has a porosity of less than or equal to 5%.

Embodiment 41: A method of any of the embodiments of embodiment 1-40, wherein the method comprises making a piston assembly comprising:
providing a ring groove insert, where the ring groove insert is a preformed solid having:
   a density from 2.5 g/cm3 to 3.0 g/cm3,
   a thermal conductivity from 140 to 170 W/m° K,
   a CTE from 15 ppm/° C. to 25 ppm/° C., and
   a porosity of less than or equal to 0.5%; and
die casting a metal or metal alloy around the ring groove insert at or above the solidus temperature of the metal or metal alloy to form a cast piston assembly.

Embodiment 42: A method of any of the embodiments of embodiment 1-41, wherein the method further comprises coating the ring groove insert before die casting.

Embodiment 43: A method of any of the embodiments of embodiment 1-42, wherein the method further comprises increasing the surface area of the ring groove insert before die casting.

Embodiment 44: A method of any of the embodiments of embodiment 1-43, wherein the method further comprises at least one of heat treating, quenching, and ageing the cast piston assembly after die casting.

Embodiment 45: A method of any of the embodiments of embodiment 1-44, wherein the method further comprises forming at least one ring groove in the ring groove insert.

Embodiment 46: An embodiment of any of the embodiments of embodiment 1-45, wherein an internal combustion engine comprises:
a piston cylinder;
a piston assembly within the piston cylinder, the piston assembly including:
a piston, the piston having a circumferential groove; and
a ring groove insert within the circumferential groove of the piston, having an outer surface and an inner surface, wherein the ring groove insert is a second material different from a first material of the piston, wherein the second material has at least one of the following:
   a) a density from 90% to 120% of a density of the first material;
   b) a coefficient of thermal expansion (CTE) from 50% to 90% of a CTE of the first material; or
   c) a thermal conductivity greater than a thermal conductivity of the first material.

Embodiment 47: An embodiment of any of the embodiments of embodiment 1-46, wherein at least one piston ring is disposed between the piston assembly and the piston cylinder in another circumferential groove extending radially inward from the outer surface of the ring groove insert.

Embodiment 48: An embodiment of any of the embodiments of embodiment 1-47, wherein the ring groove insert provides a 2.5% weight reduction over a comparative steel ring groove insert to yield a CO₂ reduction of at least 2.3 kg CO₂/liter petrol.

Embodiment 49: An embodiment of any of the embodiments of embodiment 1-48, wherein the engine has a reduction of hydrocarbon, nitrous oxides, and carbon oxides emissions, but without reducing combustion pressure and/or engine efficiency.

Embodiment 50: An embodiment of any of the embodiments of embodiment 1-49, wherein CO₂ emissions are reduced by at least 10% compared with a reference steel insert.

Embodiment 51: An embodiment of any of the embodiments of embodiment 1-50, wherein a vehicle comprises the internal combustion engine of any of the preceding embodiments.

Embodiment 52: An embodiment of any of the embodiments of embodiment 1-51, comprising a preformed ring groove insert that is a preformed solid having:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%,
wherein the insert includes 5 vol % to 60 vol % of a plurality of ceramic particles in a metal matrix.

Embodiment 53: An embodiment of any of the embodiments of embodiment 1-52, wherein a preformed solid ring groove insert includes a plurality of ceramic particles having an average particle size distribution (D50) from 0.01 μm to 10 μm.

Embodiment 54: An embodiment of any of the embodiments of embodiment 1-53, wherein a preformed ring groove insert includes a plurality of ceramic particles having an internal surface area from 100 mm²/mm³ to 1000 mm²/mm³.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims or the equivalents thereof.

1. A piston assembly comprising:
a piston having a circumferential groove; and
a ring groove insert within the circumferential groove of the piston, wherein the ring groove insert has an outer surface and an inner surface, wherein the ring groove insert is a second material different from a first material of the piston, wherein the second material has at least one of the following:
a) a density from 90% to 120% of a density of the first material;
b) a coefficient of thermal expansion from 50% to 90% of a CTE of the first material; or
c) a thermal conductivity greater than a thermal conductivity of the first material.

2. The piston assembly of claim 1, wherein the first material is aluminum, aluminum alloy, magnesium, magnesium alloy, or combinations thereof.

3. The piston assembly of claim 2, wherein the aluminum alloy includes one or more alloying elements of silicon, copper, manganese, magnesium, iron, zinc, nickel, scandium, lithium, titanium, zirconium, or tin.

4. The piston assembly of claim 1, wherein the second material is a metal matrix composite including a matrix of aluminum, aluminum alloy, magnesium, magnesium alloy, titanium, titanium alloy, or combinations thereof and from 5 vol % to 60 vol % of reinforcement particles dispersed within the matrix based upon the total volume of the second material.

5. The piston assembly of claim 4, wherein the reinforcement particles have a hardness greater than 8 and the matrix has a hardness less than 4, wherein hardness is measured according to the Mohs Hardness Scale.

6. The piston assembly of claim 4, wherein the reinforcement particles include at least one plurality of ceramic particles including carbides, oxides, silicides, borides, nitrides, or combinations thereof.

7. The piston assembly of claim 6, wherein the at least one plurality of ceramic particles include silicon carbide, boron carbide, titanium carbide, silicon boride, aluminum nitride, silicon nitride, titanium nitride, alumina, or combinations thereof.

8. The piston assembly of claim 4, wherein the metal matrix composite includes from 15 vol % to 30 vol % of the reinforcement particles based upon the total volume of the second material.

9. The piston assembly of claim 4, wherein the metal matrix composite has:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%.

10. The piston assembly of claim 4, wherein the reinforcement particles have an average particle size from 0.01 μm to 10 μm.

11. The piston assembly of claim 4, wherein the reinforcement particles have an internal surface area from 100 mm²/mm³ to 1000 mm²/mm³.

12. The piston assembly of claim 4, wherein the matrix of the second material is an aluminum alloy including from 91.2 wt % to 98.6 wt % aluminum, from 0.15 wt % to 4.9 wt % copper, and from 0.1 wt % to 1.8 wt % magnesium.

13. The piston assembly of claim 4, wherein the matrix of the second material is an aluminum alloy including from 91.2 wt % to 94.7 wt % aluminum, from 3.8 wt % to 4.9 wt % copper, from 1.2 wt % to 1.8 wt % magnesium, and from 0.3 wt % to 0.9 wt % manganese.

14. The piston assembly of claim 4, wherein the matrix of the second material is an aluminum alloy including from 95.8 wt % to 98.6 wt % aluminum, from 0.8 wt % to 1.2 wt % magnesium, and from 0.4 wt % to 0.8 wt % silicon.

15. The piston assembly of claim 4, wherein the matrix of the second material is an aluminum alloy including from 92.8 wt % to 95.8 wt % aluminum, from 3.2 wt % to 4.4 wt % copper, from 0 to 0.2 wt % iron, from 1.0 to 1.6 wt % magnesium, from 0 to 0.6 wt % oxygen, from 0 to 0.25 wt % silicon, and from 0 to 0.25 wt % zinc.

16. The piston assembly of claim 1, further including an interfacial region between the inner surface of the ring groove insert and the piston, wherein the interfacial region includes at least one intermetallic secondary phase.

17. The piston assembly of claim 17, wherein the at least one intermetallic secondary phase includes aluminum, copper, nickel, zinc, or combinations thereof.

18. A ring groove insert for a piston assembly, the ring groove insert being a preformed solid having:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%,
wherein the preformed solid is a metal matrix composite including a matrix of aluminum, aluminum alloy, magnesium, magnesium alloy, titanium, titanium alloy, or combinations thereof and 5 vol % to 60 vol % reinforcement particles dispersed within the metal matrix based upon the total volume of the preformed solid.

19. An internal combustion engine comprising:
a piston cylinder;
a piston assembly within the piston cylinder, the piston assembly including:
a piston, the piston having a circumferential groove; and
a ring groove insert according to claim 18 and disposed within the circumferential groove of the piston, having an outer surface and an inner surface,
wherein the ring groove insert is a second material different from a first material of the piston, wherein the second material has at least one of the following:
a) a density from 90% to 120% of a density of the first material;
b) a coefficient of thermal expansion (CTE) from 50% to 90% of a CTE of the first material; or
c) a thermal conductivity greater than a thermal conductivity of the first material.

20. A method of making a piston assembly comprising:
preparing a ring groove insert, wherein the ring groove insert is a preformed solid having:
a density from 2.5 g/cm³ to 3.0 g/cm³,
a thermal conductivity from 140 to 170 W/m° K,
a CTE from 15 ppm/° C. to 25 ppm/° C., and
a porosity of less than or equal to 0.5%; and
die casting a metal or metal alloy around the ring groove insert at or above the solidus temperature of the metal or metal alloy to form a cast piston assembly, wherein the metal or metal alloy is a first material, and wherein the ring groove insert is a second material different from the first material, wherein the second material has at least one of the following:
a) a density from 90% to 120% of a density of the first material;
b) a coefficient of thermal expansion (CTE) from 50% to 90% of a CTE of the first material; or
c) a thermal conductivity greater than a thermal conductivity of the first material.
